(19) United States
(12) Patent Application Publication
(10) Pub. No.: US 2009/0120122 A1
(43) Pub. Date: May 14, 2009

(54) Water supply for supplyingan ice cube maker and/or a water dispenser of a refrigerator and/or freezer

(76) Inventors: Manfred Gradl, Oberdrauburg (AT); Thomas Obererlacher, Lienz (AT)

Correspondence Address: DILWORTH & BARRESE, LLP, 333 EARLE OVINGTON BLVD., SUITE 702, UNIONDALE, NY, 11553, US

(21) Appl. No.: 11/918,514

(22) PCT Filed: Apr. 13, 2006
(86) PCT No.: PCT/EP2006/003436

§ 371 Date: Jan. 2, 2009

(30) Foreign Application Priority Data
Apr. 15, 2005 (DE) 20 2005 006 075.5
May 11, 2005 (DE) 20 2005 007 482.9

(51) Int. Cl. B67D 5/06

(52) U.S. Cl. 62/389

(57) ABSTRACT

The present invention relates to a water supply device for the water supply of an ice cube maker and/or water dispenser of a refrigerator and/or freezer, comprising a water tank, which includes a filling hole for manually filling the water tank and an outlet connection for connecting the water tank to a supply conduit of the ice cube maker and/or water dispenser. The invention furthermore relates to a refrigerator and/or freezer with such a water supply device. The invention is based on the idea to combine the advantages of a fixed water connection with the advantages of a manually fillable water tank. In accordance with the invention, it is proposed to use a manually fillable water tank on which a fixed water connection is provided for connection of the water tank to a stationary water conduit. The water supply device thereby can selectively be operated manually, in particular when no fixed water connection is provided, or automatically, when such fixed water connection is provided. In this way, the comfort of a fixed water connection is incorporated, but the presence of a stationary water conduit is no condition for mounting or operating the refrigerator with water supply point. In automatic operation, the combination of the manually fillable water tank with the fixed water connection also provides advantages over pure solutions with fixed water connection. Thus, a simple cleaning of the system can be achieved by adding a cleaning agent through the filling hole of the water tank. Other additives also can easily be added to the water to be dispensed. Moreover, when switching over to automatic operation, the first tank fill-up, in particular the water present in the supply conduit for an extended period, can be disposed of in a fast and uncomplicated way by draining the tank.

The present invention relates to a water supply device for the water supply of an ice cube maker and/or water dispenser of a refrigerator and/or freezer, comprising a water tank, which includes a filling hole for manually filling the water tank and an outlet connection for connecting the water tank to a supply conduit of the ice cube maker and/or water dispenser. The invention furthermore relates to a refrigerator and/or freezer with such a water supply device.

Refrigerators or freezers with a water consumption point, such as an ice cube maker or a water dispenser for dispensing cooled water, must be connected to a corresponding water supply. This is regularly accomplished in that a fixed water connection is provided on the refrigerator or freezer, by means of which the refrigerator, similar to a washing machine, can be connected to the stationary water installation of a building. Whenever the water supply point of the refrigerator or freezer needs water, the same is automatically withdrawn in the required quantity via the fixed water connection from the stationary water installation.

It is, however, disadvantageous that a corresponding water connection must be provided. Such a refrigerator cannot be used in rooms which do not have a water installation.

Therefore, it has already been proposed to provide such refrigerators which have a water supply point, e.g. an ice cube maker or a cooled water dispenser, with a water tank which can be filled manually via a filling hole. In the water tank, a relatively large amount of water can be stored, so that over a sometimes considerable period sufficient water is available for instance for the ice cube maker. The water tank merely needs to be refilled at relatively large time intervals.

Such refrigerator with water-tank is disclosed for instance in DE 196 44 090 A1, in which the water level in the water tank is detected via the pump operating period and a low-water lamp is activated when a low level is reached.

In this respect, it is the object underlying the present invention to create an improved water supply device of the type mentioned above and an improved refrigerator with such a water supply device, which eliminate the disadvantages of the prior art and develop the latter in an advantageous way. Preferably, an automatic water supply should be made possible, but a manual supply should not be sacrificed.

In accordance with the invention, this object is solved by a water supply device according to claim 1 and a refrigerator and/or freezer according to claim 11. Preferred aspects of the invention are subject-matter of the dependent claims.

Thus, the invention proceeds from the idea to combine the advantages of a fixed water connection with the advantages of a manually fillable water tank. In accordance with the invention, it is proposed to use a manually fillable water tank on which a fixed water connection is provided for connecting the water tank to a stationary water conduit. The water supply device thereby can selectively be operated manually, in particular when no fixed water connection is provided, or automatically, when such fixed water connection is provided. In this way, the comfort of a fixed water connection is incorporated, but the presence of a stationary water conduit is no condition for mounting or operating the refrigerator with water supply point. In automatic operation, the combination of the manually fillable water tank with the fixed water connection also provides advantages over pure solutions with fixed water connection. Thus, a simple cleaning of the system can be achieved by adding a cleaning agent through the filling hole of the water tank. Other additives also can easily be added to the water to be dispensed. Moreover, when switching over to automatic operation, the first tank fill-up, in particular the water present in the supply conduit for an extended period, can be disposed of in a fast and uncomplicated way by draining the tank.

In accordance with a development of the invention, a by-pass conduit can be provided between the fixed water connection and the outlet connection of the water tank, via which the outlet connection of the water tank can be fed with water from the fixed water connection by-passing the water tank. In this way, water from the fixed water connection can also be fed directly into the outlet connection or the supply conduit connected therewith, for instance of the ice cube maker or water dispenser. This can be advantageous, for instance, when a water request of the ice cube maker nevertheless should be satisfied without delay with an empty water tank or when for instance water with flavouring additives for the water dispenser is stored in the water tank, but water without such flavouring additives temporarily is required for the ice cube maker.

Advantageously, the water supply device has a switching device for switching between automatic operation with fixed water supply and manual operation with manual filling of the water tank. If the refrigerator is mounted in a room without fixed water connection, it is possible to switch over to manual operation. On the other hand, the automatic operation can be chosen for increased comfort, when a fixed water connection is provided. The switching mechanism can be of the electric, electronic or mechanical type. The user thereby can easily determine whether an automatic or manual filling of the water tank is provided.

Preferably, a valve, preferably a solenoid valve, can be provided in the aforementioned by-pass conduit, by means of which the flow of water through the by-pass conduit can be controlled. In particular, the by-pass conduit can be blocked by means of this valve, so that water is supplied from the fixed water connection into the tank and the outlet connection is fed with water from the tank. When the by-pass conduit valve is opened, however, the direct feeding of the supply conduit connected to the outlet connection is effected via the fixed water connection.

Alternatively or in addition to such by-pass conduit valve, a valve, in particular a solenoid valve, can be associated to the fixed water connection and/or the outlet connection for controlling the flow of water into the water tank and/or out of the water tank. By providing such valves, it is in particular possible to easily switch between automatic operation and manual operation. If filling should be effected automatically, the fixed water connection can be enabled. However, if filling should be effected manually, the fixed water connection can be blocked. By means of the outlet connection valve, this outlet connection likewise can be opened and blocked. In particular, water removal can be prevented thereby when the level in the water tank is too low, or the output connection can be blocked, in order to remove the water tank from the refrigerator and/or freezer, for instance for the purpose of filling. Advantageously, the water tank is designed to be removable. For this purpose, the outlet connection and the fixed water connection can include releasable connecting means, which, however, is not absolutely necessary to be able to remove the water tank.

In accordance with a development of the invention, the water supply device comprises a filling level detection means for detecting the filling level of the water tank. In dependence on a signal of the filling level detection means, a display possibly can be actuated, which indicates whether the water tank is filled sufficiently or whether water must be refilled. In accordance with one embodiment of the invention, the filling level detection means can include an upper filling level switch, which responds when an upper filling level is reached, and a lower filling level switch, which responds when the level falls below a lower filling level.

Advantageously, one of the aforementioned valves can be actuated in dependence on the detected filling level. For this purpose, a control means can be provided, which on the one hand is connected with the aforementioned fixed water connection valve, the outlet connection valve and/or the by-pass valve, and on the other hand is connected with the aforementioned filling level detection means. For instance, the control means can be formed such that upon reaching a predetermined upper filling level in the water tank, the fixed water connection is blocked, so that no excess pressure can be produced in the water tank. Alternatively or in addition, the fixed water connection can be enabled when a predetermined lower filling level in the water tank is reached or the level falls below said lower filling level, so that an automatic refilling of the water tank is achieved. When reaching the lower filling level, the output connection possibly can be blocked alternatively or in addition, so that no further water can be removed. Alternatively or in addition, the by-pass valve can also be opened when the lower filling level is reached, in order to ensure the water supply in the case of a simultaneous water request of the ice cube maker and/or the water dispenser.

The aforementioned control means also can cooperate with the switching means for switching between automatic and manual operation. In particular, the control means can block the fixed water connection and the by-pass conduit when switching over to manual operation, whereas when switching over to automatic operation it at least enables the fixed water connection, possibly also the by-pass conduit. This control function of the control means in dependence on a signal of the switching means for switching between automatic and manual operation can be provided alternatively or in addition to the aforementioned control function in dependence on the filling level of the water tank.

In principle, the fixed water connection and the outlet connection can be provided at different points of the water tank. According to an advantageous embodiment of the invention, the fixed water connection is located above the outlet connection. In particular, the fixed water connection can be connected with the water tank at an upper end portion thereof, whereas the outlet connection is connectable with a bottom portion of the water tank.

Advantageously, the water tank has a bottom inclined towards one side. Such inclination of the tank on the one hand ensures an optimum seat of the water tank in a corresponding water tank holder. Via the inclined bottom, the weight of the water tank and its contents urge the water tank in a predetermined direction against a stop. In particular, the bottom is sloping downwards to the outlet connection and/or the fixed water connection, so that the contact force generated via the inclined bottom urges the water tank in the direction of its outlet connection and/or its fixed water connection. Advantageously, the fixed water connection and the outlet connection are provided on the same side of the water tank.

On the other hand, it can be achieved by means of an inclined bottom and a corresponding arrangement of the outlet connection that always the older charge of the water tank is used first. For this purpose, the outlet connection can communicate in particular with that portion of the water tank which is located above the deepest point of the inclined bottom.

The supply conduit connected to the outlet connection of the water tank expediently is fitted with a pump, by means of which the supply of the ice cube maker and/or the water dispenser is effected.

The invention will subsequently be explained in detail with reference to a preferred embodiment and associated drawings, in which:

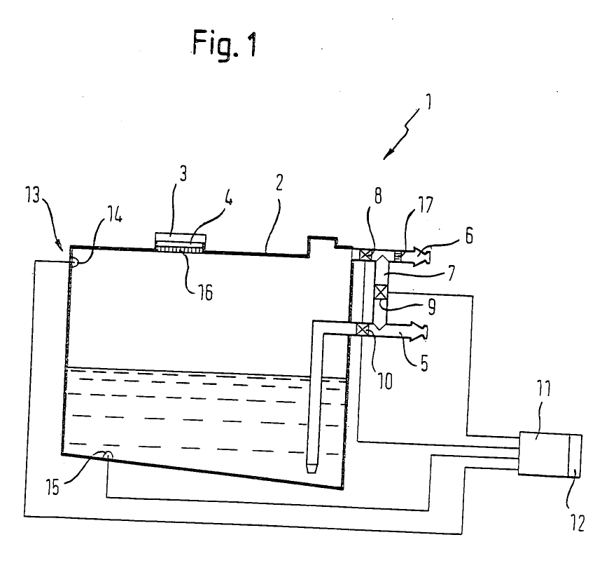

FIG. 1: shows a schematic representation of a water supply device comprising a water tank with fixed water connection and manual filling hole for supplying an ice cube maker and a water dispenser of a refrigerator and freezer.

The water supply device 1 as shown in FIG. 1 can be incorporated in a refrigerator and freezer not illustrated for reasons of clarity, and in particular comprises the water tank, which in the FIGURE is designated with reference numeral 2 and consists of a container of sufficient size, which is closed on all sides.

As shown in FIG. 1, the water tank 2 comprises a manual filling hole 4 on its upper surface, which can be closed by a lid 3 and through which the water tank 2 can manually be filled with water or some other desired liquid. Furthermore, the filling hole 4 also is intended and dimensioned sufficiently for adding all kinds of additives into the water tank 2, for instance cleaning agents, flavouring additives and the like.

The liquid stored in the water tank 2 can be dispensed via an outlet connection 5, which is mounted on a side wall of the water tank 2 in the upper third thereof, but inside the water tank communicates with a bottom portion thereof, in order to be able to also dispense water with a low filling level of the water tank and withdraw water from the lower region of the water tank.

The outlet connection 5 of the water tank 2 is connected to a supply conduit, through which liquid can be delivered from the outlet connection 5 to an ice cube maker and a water dispenser of the refrigerator and freezer by means of a non-illustrated pump.

On the same side wall of the water tank 2, a fixed water connection 6 furthermore is provided at the upper edge thereof, which communicates with the interior of the water tank 2 in the vicinity of its lid. To the fixed water connection 6, a stationary water conduit can be connected, which is provided in the building in which the refrigerator is mounted. As a result, the water tank 2 can be filled automatically by feeding water via the stationary water conduit through the fixed water connection 6 into the water tank 2.

Furthermore, between the fixed water connection 6 and the outlet connection 5 a by-pass conduit 7 is provided, which connects the fixed water connection 6 with the outlet connection 5 outside the water tank 2.

As shown in FIG. 1, three preferably electrically actuatable valves are provided in the connections of the water tank or in the by-pass conduit between the same, wherein these valves preferably can constitute magnetic on-off or shut-off valves. A fixed water connection valve 8 is provided in the fixed water connection 6 downstream of the branch-off of the by-pass conduit 7, in order to be able to shut off its connection with the water tank 2. A by-pass conduit valve 9 is located in the by-pass conduit 7, in order to be able to shut off or enable the same. Finally, an outlet connection valve 10 is located in the outlet connection 5 upstream of the junction of the by-pass conduit 7.

The three valves 8, 9 and 10 are actuatable by a control means 11, which is connected with a switching device 12, by means of which a user or a mechanic can switch the water supply between manual operation and automatic operation. As described above, the control means 11 correspondingly actuates the valves 8, 9 and 10 in dependence on the signal of the switching device 12.

Furthermore, the control means 11 is connected with a filling level detection means 13, which includes an upper filling level limiter 14 and a lower filling level limiter 15 on the water tank 2. If the water level in the water tank 2 reaches the upper filling level limiter 14, the same provides a corresponding signal, whereas the lower filling level limiter 15 provides a signal when the water level in the water tank 2 falls below the lower filling level limiter 15. In dependence on the signals of the two filling level limiters 14 and 15, the control means 11 can actuate the solenoid valves 8, 9 and 10 as described above, in particular to ensure an automatic water supply or, in manual operation, to block the output of water when the water level falls below the lower filling level.

As shown in FIG. 1, the bottom 16 of the water tank 1 is sloping down to the side on which the fixed water connection 6 and the outlet connection 10 are provided. The outlet connection 10 communicates with the deepest portion of the water tank 2.

The water supply device 1 as shown in FIG. 1 in particular can perform the following functions: If automatic operation with automatic supply of water via the fixed water connection 6 is chosen, it can be detected by means of the filling level detection means 13 whether filling of the water tank 2 is required. Such filling is activated when the level falls below the lower filling level limiter 15. This ensures that the system does not run idle. By enabling the fixed water connection valve 8, the water tank is filled, until the upper filling level limiter 13 is reached.

It should be appreciated that in automatic operation it is also possible to add all kinds of additives via the manual filling hole 4. Furthermore, when using the fixed water connection 6, it can be achieved via the control means 11 and the solenoid valves, in particular the by-pass conduit valve 9, that the liquid can directly be utilized for the liquid dispenser or the ice cube maker without preceding cooling in the water tank 2.

In manual operation, the water tank 2 can selectively be filled in the installed condition or be removed, i.e. be removed from the refrigerator and freezer, in order to be filled. In both cases, filling is effected via the filling hole 4. When the manual operating mode is chosen, an acoustic or optical signal is provided when the level falls below the lower filling level limiter 15, in order to indicate that refilling is required. Furthermore, the possibility of withdrawing liquid is stopped by blocking the outlet connection valve 10.

To achieve a filtering of the water for the ice cube maker or the water dispenser, a water filter advantageously can be used in the inlet of the device, in particular be associated to the filling hole 4 and/or the fixed water connection 6. FIG. 1 shows water filters 16 and 17 both in the filling hole 4 and in the fixed water connection 6. It should be appreciated that water filters preferably are removable, in order to be cleaned or replaced.

1. A water supply device for the water supply of an ice cube maker and/or a water dispenser of a refrigerator and/or freezer, comprising a water tank (2) which includes a filling hole (4) for manually filling the water tank (2) and an outlet connection (5) for connection of the water tank to a supply conduit of the ice cube maker and/or the water dispenser, wherein the water tank (2) has a fixed water connection (6) for connection of the water tank (2) to a stationary water conduit.

2. The water supply device according to claim 1, wherein between the fixed water connection (6) and the outlet connection (5) a by-pass conduit (7) is provided, through which the outlet connection (5) can be fed with water from the fixed water connection (6) by by-passing the water tank (2).

3. The water supply device according to claim 1, wherein a switching device (12) is provided for switching between automatic operation with fixed water supply and manual operation with manual filling of the water tank (2).

4. The water supply device according to claim 1, wherein a by-pass conduit valve (9), preferably a solenoid valve, is provided for controlling the flow of water between the fixed water connection (6) and the outlet connection (5) by-passing the water tank (2).

5. The water supply device according to claim 1, wherein a fixed water connection valve (8) and/or an outlet connection valve (10), in particular a solenoid valve, is provided for controlling the flow of water into the water tank (2) and/or out of the water tank (2).

6. The water supply device according to claim 1, wherein a filling level detection means (13) is provided for detecting the filling level of the water tank (2), which preferably includes an upper filling level switch (14) and a lower filling level switch (15).

7. The water supply device according to claim 1, wherein a control means (11) is provided for actuating the fixed water connection valve (8), the outlet connection valve (10) and/or the by-pass conduit valve (9) in dependence on the filling level of the water tank (2) and/or in dependence on the switching signal indicating either automatic operation or manual operation.

8. The water supply device according to claim 1, wherein the fixed water connection (6) is connected with a first water tank portion, which is located above a second water tank portion with which the outlet connection (5) is connected, wherein preferably the fixed water connection (6) is connected with the water tank at an upper end portion thereof and/or the outlet connection (5) is connected with a bottom portion of the water tank (2).

9. The water supply device according to claim 1, wherein the water tank (2) has a bottom (16) inclined towards one side and the outlet connection (5) is connected with a water tank portion above the deepest bottom portion.

10. The water supply device according to claim 1, wherein a pump is provided for delivering the water from the outlet connection (5) of the water tank to the ice cube maker and/or the water dispenser.

11. A refrigerator and/or freezer with a water supply device (1) according to claim 1, comprising an ice cube maker and/or water dispenser connected therewith.

12. The refrigerator and/or freezer according to claim 11, wherein the water tank (2) of the water supply device is formed to be removable from the body of the refrigerator and/or freezer, and preferably has releasable connecting means on its outlet connection (5) for releasable connection with the supply conduit of the ice cube maker and/or water dispenser.

13. The water supply device according to claim 2, wherein a switching device (12) is provided for switching between automatic operation with fixed water supply and manual operation with manual filling of the water tank (2).

14. The water supply device according to claim 13, wherein a by-pass conduit valve (9), preferably a solenoid valve, is provided for controlling the flow of water between the fixed water connection (6) and the outlet connection (5) by-passing the water tank (2).

15. The water supply device according to claim 3, wherein a by-pass conduit valve (9), preferably a solenoid valve, is provided for controlling the flow of water between the fixed water connection (6) and the outlet connection (5) by-passing the water tank (2).

16. The water supply device according to claim 2, wherein a by-pass conduit valve (9), preferably a solenoid valve, is provided for controlling the flow of water between the fixed water connection (6) and the outlet connection (5) by-passing the water tank (2).

17. The water supply device according to claim 16, wherein a fixed water connection valve (8) and/or an outlet connection valve (10), in particular a solenoid valve, is provided for controlling the flow of water into the water tank (2) and/or out of the water tank (2).

18. The water supply device according to claim 15, wherein a fixed water connection valve (8) and/or an outlet connection valve (10), in particular a solenoid valve, is provided for controlling the flow of water into the water tank (2) and/or out of the water tank (2).

19. The water supply device according to claim 14, wherein a fixed water connection valve (8) and/or an outlet connection valve (10), in particular a solenoid valve, is provided for controlling the flow of water into the water tank (2) and/or out of the water tank (2).

20. The water supply device according to claim 13, wherein a fixed water connection valve (8) and/or an outlet connection valve (10), in particular a solenoid valve, is provided for controlling the flow of water into the water tank (2) and/or out of the water tank (2).
